(19) United States
(12) Patent Application Publication
(10) Pub. No.: US 2015/0143281 A1
(43) Pub. Date: May 21, 2015

(54) NOTIFICATIONS AND REMINDERS BASED ON USER STATES

(71) Applicant: Apple Inc., Cupertino, CA (US)

(72) Inventors: Sarin S. Mehta, Cupertino, CA (US); Ioan V. Uilecan, Cupertino, CA (US)

(73) Assignee: Apple Inc., Cupertino, CA (US)

(21) Appl. No.: 14/084,527

(22) Filed: Nov. 19, 2013

(51) Int. Cl. G06F 3/0484; G06F 3/0482

(52) U.S. Cl. CPC G06F 3/04847; G06F 3/0482
USPC 715/781

(57) ABSTRACT

Methods and apparatus are disclosed for deferring a first reminder notification by, in one or more embodiments, displaying a reminder deferral user interface in response to the first reminder notification, the reminder deferral user interface specifying deferral options, including at least one deferral trigger condition, receiving a request to defer the first reminder notification, the request comprising a selected deferral trigger condition that indicates when a second reminder notification is to be presented, the selected deferral trigger condition being based upon state information associated with the computer system, and scheduling the second reminder notification to present a deferred reminder user interface at a subsequent time at which the selected deferral trigger condition is met. Also disclosed are methods and apparatus for generating follow-up reminders until a reminder action has been performed, by scheduling, a follow-up notification to occur at a subsequent time or to occur when a condition is met.

### TECHNICAL FIELD

The present invention relates generally to notifications and reminders that are presented to users in computer systems. More particularly, the present embodiments relate to notifications and reminders that are presented to users based on information about user activity or state.

### BACKGROUND

On mobile devices and other computer systems, reminders can be created by users to remind themselves of tasks that they wish to attend to at a future time. For example, a user can create a reminder on a mobile phone by specifying text to be displayed, such as “Go to store” and a time at which the text is to be displayed, such as 7:00 PM. Then, at the specified time, a visual notification, such as a popup containing the reminder text is displayed on the computer system or mobile device. A sound or other type of notification can also be generated to attract the user's attention. Reminders can also be requested to occur when the computer or mobile device is at a specified geographic location. For example, a location-based reminder can be set with the text “Call home” and the geographic coordinates of the user's office to remind the user to call home upon arrival at their office. The reminder text ordinarily remains prominently visible on the display until dismissed or rescheduled by the user. A dismissed reminder is not presented again. A rescheduled reminder can be displayed again in a subsequent notification at a future time, ordinarily after a predefined duration of time, such as ten minutes.

To get the user's attention, a reminder notification can block or interrupt other components of the user interface of the computer system or device until dismissed or rescheduled. However, the reminder notification may be displayed at an inconvenient time, such as during a meeting or phone call, or while the user is driving, in which cases the user is likely to dismiss the notification without performing the indicated action, or not see the notification until much later, e.g., if the device is not near the user. Further, if the user is performing a task with the mobile device, the notification interrupts the task, and the user may dismiss the notification to continue with the task. Therefore, it would be desirable to be able to generate reminders that are more likely to be acted upon by users.

### SUMMARY

In one or more embodiments, enhanced reminder notifications are provided. Enhanced reminder notifications can be deferred until a later time, and/or automatically repeated until an action associated with the reminder has been performed. Deferrable reminder notifications can be postponed until a future time or event, at which point the deferred notification is again triggered presented. Postponing a notification can also involve requesting that a particular action be performed when the notification is again presented. The user can defer notifications by selecting a deferral option in the notification popup. Alternatively, notifications can be deferred automatically, e.g., according to rules that are based on the device's state, and a deferred notification can be configured to perform an action other than displaying the notification, such as making a call, getting map directions to a location, and so on when subsequently triggered.

In one or more embodiments, a follow-up reminder verification can be performed, after a reminder notification has been presented, to verify that the user actually performs the task. For example, if a reminder indicates that the user is to call a particular person, then the follow-up verification can check whether the user has actually called that person, and, if not, the reminder can be presented again. The follow-up verification can continue to generate further reminders, e.g., at specified time intervals, until the user calls the person. As another example, if the reminder indicates that the user is to go to a particular location, then the follow-up verification can present the reminder one or more times if the user has not gone to the location. Time-based and location-based conditions can both be used in the follow-up verification, e.g., to verify that the user arrives at a particular location within a particular amount of time.

### BRIEF DESCRIPTION OF THE DRAWINGS

The included drawings are for illustrative purposes and serve only to provide examples of possible structures and arrangements for the disclosed inventive apparatuses and methods for providing portable computing devices. These drawings in no way limit any changes in form and detail that may be made to the invention by one skilled in the art without departing from the spirit and scope of the invention. The embodiments will be readily understood by the following detailed description in conjunction with the accompanying drawings, wherein like reference numerals designate like structural elements, and in which:

FIG. 1 is a block diagram of a reminder system that executes on a mobile device in accordance with one or more embodiments.

FIG. 2 is an illustrative drawing of a reminder data structure in accordance with one or more embodiments.

FIG. 3 is an illustrative flowchart of a process for deferring notifications in accordance with one or more embodiments.

FIG. 4 is an illustrative flowchart of a process for deferring notifications in accordance with one or more embodiments.

FIG. 5 is an illustrative drawing of a reminder creation user interface in accordance with one or more embodiments.

FIG. 6 is an illustrative drawing of a reminder notification user interface in accordance with one or more embodiments.

FIG. 7 is a block diagram of an electronic device suitable for use with the described embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

Existing reminder systems can present reminders at specified times or when specified events occur. The reminders are presented as notifications with short text descriptions, which can be displayed on a computer system such as a mobile device, and can be accompanied by audio signals such as alarm sounds. A user can create a reminder that displays a specified message of text at a specified time or when the device is located at specified geographic coordinates. When the specified time or location is reached, a reminder notification is displayed as a popup or the like on the device's screen, with options that the user can select to dismiss the popup.

Reminder notifications can be displayed with options for rescheduling the notifications to occur again at a future time or location, e.g., to request notification again in 10 minutes, or when the device's location reaches the user's home address. These options are available, for example, in the FaceTime® video calling application from Apple Inc. of Cupertino, Calif. when a reminder occurs during a video call. However, there are many scenarios in which a reminder notification interrupts an application in use on the device, such as during a phone call or video recording. These interruptions can be disruptive for users. Further, users can dismiss reminders without actually performing the action described in the reminder. After a reminder has been dismissed, it does not ordinarily appear again, so a user may forget to perform the action, particularly if the reminder occurs at an inconvenient time.

The techniques described herein address these deficiencies in existing reminder systems by providing enhanced reminder notifications that can be deferred until a later time, and/or repeated until an action associated with the reminder has been performed.

In one or more embodiments, deferrable reminder notifications can be postponed until a future time or event, at which point the deferred notification is again presented. Postponing a notification can also involve requesting that a particular action be performed when the notification is again presented. The user can defer notifications by selecting a deferral option in the notification popup. Alternatively, notification can be deferred automatically, e.g., according to rules that are based on the device's state, and a deferred reminder can be configured to perform an action other than displaying the notification, such as making a call, getting map directions to a location, and so on.

In one or more embodiments, follow-up notification reminders can be generated. A follow-up verification can be performed, after a reminder notification has been presented, to verify that the user actually performs the task. For example, if a reminder indicates that the user is to call a particular person, then the follow-up verification can check whether the user has actually called that person, and, if not, the reminder can be presented again. The follow-up verification can continue to generate further reminders, e.g., at specified time intervals, until the user calls the person. As another example, if the reminder indicates that the user is to go to a particular location, then the follow-up verification can present the reminder one or more times if the user has not gone to the location. Time-based and location-based conditions can both be used in the follow-up verification, e.g., to verify that the user arrives at a particular location within a particular amount of time.

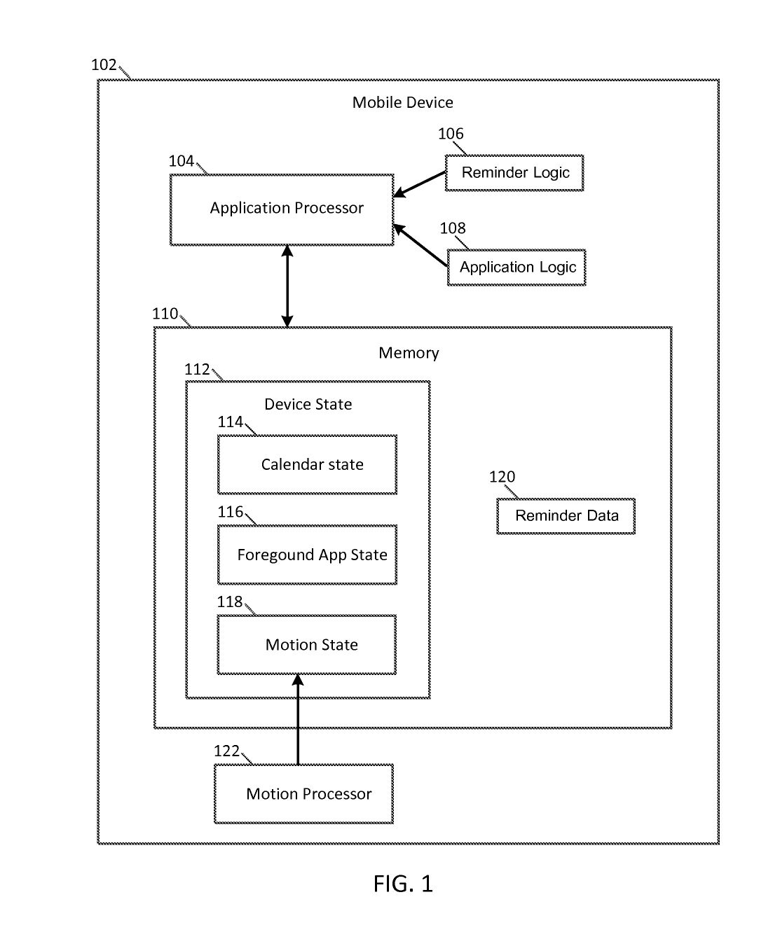

FIG. 1 is a block diagram of a reminder system that executes on a mobile device 102 in accordance with one or more embodiments. Application processor 104 executes reminder logic 106 and application logic 108. The application processor can retrieve state information 112 from a memory 110 and make the state information available to the reminder logic 106. The state information 112 can include calendar state 114, foreground application state 116, and motion state 118. The motion state information 118 can be received from a motion processor 122. Other input sources are possible, e.g., GPS location, audio input, and so on. The reminder logic 106 creates reminders based on user input, generates and displays reminder notifications, and implements deferred reminders and follow-up verification of reminders as described in the following figures. The reminders can be stored in memory 110 as reminder data 120, and persistently stored in a storage medium such as a disk, database, or network-accessible database.

In one or more embodiments, when a reminder is triggered, e.g., occurs at its scheduled time or specified location, a reminder notification is presented. The notification can be displayed as a popup or alert, and includes options that enable the user to defer the reminder until a selected future time or event occurs. The deferred reminder can then be displayed again when the future time or event occurs. Alternatively, instead of re-displaying the reminder, a different action can be performed, such as placing a call or displaying directions to a location, can be performed. The particular action to be performed can be selected by the user when the initial reminder notification is presented, or specified when the reminder definition is created or modified, e.g., in a reminders application.

Deferred notifications can be understood as notifications that were originally scheduled to be presented at a particular time, but have been rescheduled to occur at a later time. The rescheduling can be a result of an explicit deferral, e.g., a user selecting a deferral option in the notification popup. The rescheduling can also be a result of an automatically deferral, which can occur when presenting a notification at its originally scheduled time would have been inappropriate, e.g., because the user was busy. The determination of whether presenting a notification is appropriate can be made at a particular time based on device state information. The device state information can be used to determine the user's state, or at least an approximation thereof. In one example, when automatic deferrals are enabled, and a determination is to be made as to whether a notification is to be presented or deferred, a notification deferral condition can be evaluated based on the device's state information, such as the user's calendar schedule, the application currently executing in the foreground on the device, or device motion information. The notification deferral condition can be a condition that determines whether the user is on the phone, or in a meeting, or driving, or running, and so on, based on the device state information. The notification deferral condition is true when the notification should be deferred, and false if the notification should be presented to the user. When the notification deferral condition is true, the notification can be rescheduled to occur at a later time.

For example, if a reminder triggers while the user is in a meeting, according to the user's calendar information, then the reminder notification can be presented with an option to defer the reminder until after the meeting, at which time the reminder notification will be presented again. If automatic deferral is enabled, then the reminder notification is not presented when the reminder triggers, but is instead rescheduled. The notification can be rescheduled to occur after the meeting.

As another example, if a reminder notification triggers while the user is driving a vehicle, e.g., according to motion information gathered by the device, then the reminder can include an option to defer the notification until the user starts walking. The notification deferral condition is true when the user is driving because the motion information in the device's state indicates movement at a relatively high speed. The notification deferral condition becomes false when the user stops driving and starts walking, because the motion information changes to indicate that the user's speed has decreased to a walking speed. In one example, the notification deferral condition can be monitored for changes, and, when a change occurs, the condition can be evaluated to determine if the notification can be presented at the current time. If so, the notification is presented at the current time.

Further, if a reminder triggers while the user is using an application on the device, such as a video recorder or telephone application, then the reminder can include an option to defer the reminder until the video or telephone application becomes inactive. The notification deferral condition is true when the user is using the video recorder or telephone application (or other application for which an interruption is inappropriate), which occurs when one of those applications is executed in the foreground (e.g., with a user interface being displayed on the device's screen). The notification deferral condition becomes false when an application for which interruption is inappropriate is no longer executing in the foreground, at which point the deferred notification can be presented.

In one or more embodiments, when a reminder triggers, a deferral until a future time or event can occur automatically, i.e., without presenting a reminder notification. That is, instead of presenting a reminder notification, the reminder system can consult information related to the current state of the device, such as the application currently being used on the mobile device, the motion of the mobile device (e.g., whether the user is driving), the user's current activity, such as whether the user is in a meeting, and so on. In other examples, the notification can be delayed if the user is watching a movie, in which case the reminder can be deferred until after the movie, or if the user is on an airline flight, in which case the reminder can be deferred until the flight lands.

In one or more embodiments, follow-up verification can be performed after a reminder notification has been presented, based on the state of the device, to verify that the user has performed the task or activity associated with the reminder, or has explicitly overridden (e.g., cancelled) the reminder verification. The follow-up check can be done repeatedly until the user has performed the task or cancelled the reminder. For example, the notification can be repeated, e.g., displayed at subsequent times, according to a defined interval, until the user performs the task. The interval can be any appropriate or selected time interval, e.g., one hour, one day, or the like.

In another example, the notification can be repeated (e.g., displayed again) when an event occurs, such as when the user arrives at a destination. The user's location can be determined using a location service on the mobile device, such as a GPS device. The notification can be repeated when the user arrives at a destination that is named in the reminder text or otherwise associated with the reminder, or when the user's motion indicates a transition from driving to walking, for example.

In one or more embodiments, notification deferral and notification follow-up (i.e., repeated notification) can be performed independently of each other. For example, the reminder notification can be deferred based on state information, but the follow-up verification can be omitted. In another example, the reminder notification can be presented without checking the state information, but the follow-up verification can still be performed.

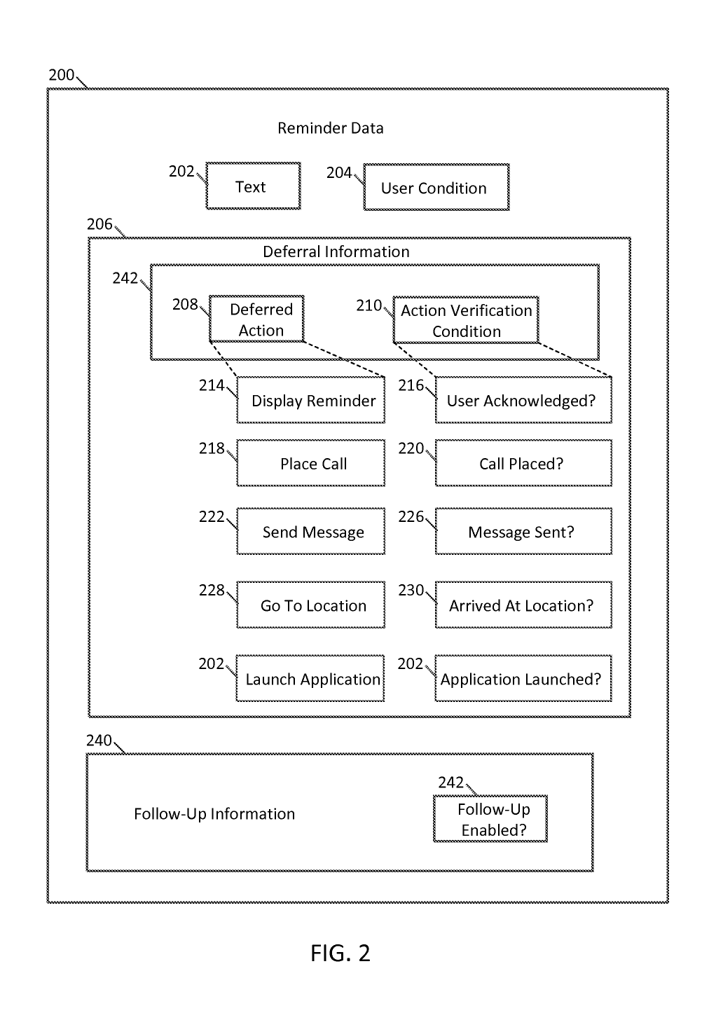

FIG. 2 is an illustrative drawing of a reminder data structure 200 in accordance with one or more embodiments. The reminder data 200 represents a reminder and can be stored in device memory 110 as reminders 120. The reminder data 200 includes reminder text 202, which can be received when the reminder is created, and displayed when the reminder is presented, and has a value that describes the action that the user is to be reminded of, e.g., “Call Ted.” The reminder data 200 also includes a user condition 204, which represents a condition with which the reminder is created, at which a notification is to be presented. The user condition 204 can be, for example, an absolute time being reached, a relative time passing, the device reaching a specified location, and the like. The user condition 204 can represent the reminder condition if the reminder has not been deferred. The reminder data also includes a Follow Up Enabled value, which, if true, indicates that follow-up verification is enabled for the reminder represented by reminder data 200. The reminder data 200 also includes deferral information 206, which in turn includes a deferred action 208 and an action verification condition 210. The action verification condition 210 can be used to automatically verify that the corresponding action has been completed for a particular instance of the reminder 200, by evaluating the verification condition 210. Possible values for the deferred action 208 and action verification condition 210 are shown for illustrative purposes. The deferred action 208 does not necessarily include all the values shown in FIG. 2, although multiple values can be included to specify a list of multiple actions to be performed. Similarly, the action verification condition 210 does not ordinarily include all the values shown. Other values for the deferred action 208 and verification condition 210 are also possible, in addition to or in place of the values shown. The values shown include a Display Reminder action 214, which represents an action that displays a reminder notification and has an associated User Acknowledged verification condition 210, which can be evaluated to determine if a user has acknowledged a reminder notification for the associated reminder 200. A Place Call action 218 represents an action that initiates a phone call using the device's phone application and hardware. A Call Placed verification condition 220 can be evaluated to determine if a call has been placed for the associated reminder 200. A Send Message action 222 represents an action that sends text and email messages. A Message Sent verification condition 226 can be evaluated to determine if a text or email message has been sent. A Go To Location action 228 represents an action that involves moving to a specified location, which can include, e.g., getting map directions to the location. An Arrived At Location condition 230 can be evaluated to determine if the device has arrived at the corresponding location. A Launch Application action 232 represents an action that launches a specified application on the device, and an Application Launched condition can be evaluated to determine if the application has been launched for the reminder 200. Additional data, such as an application name, can be associated with the deferred action 208 as needed.

In one or more embodiments, the Reminder Data 200 also includes Follow-Up Information 240, which can be used when creating follow-up notifications. The Follow-Up Information 240 includes a follow-up enabled flag, which indicates whether follow-up reminders are enabled for the reminder 200. Note that one or more of the data items shown in the reminder data 200 can be stored as part of the reminder data 200, or associated with the reminder data 200, e.g., by a reference or pointer.

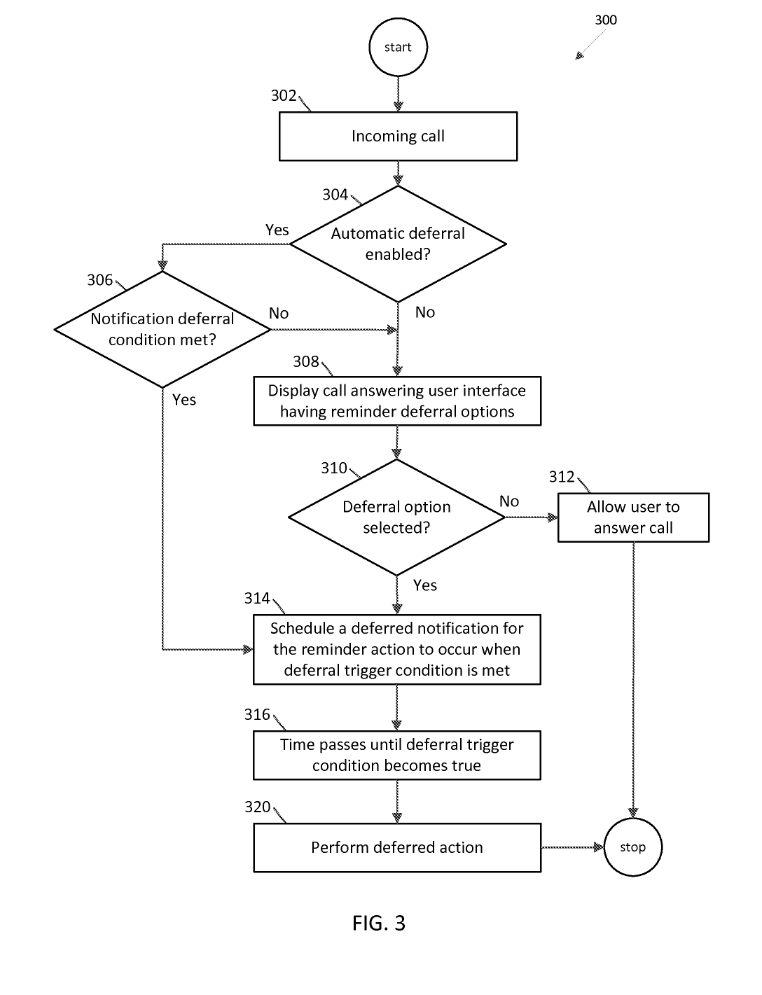

FIG. 3 is an illustrative flowchart of a process 300 for deferring notifications in accordance with one or more embodiments. The process 300 can be implemented as, for example, computer program code stored on a computer readable medium and executable by a processor to perform the described operations. Notifications can be deferred in a number of situations involving reminders or long-running user interactions, including when a user creates a reminder (e.g., in a reminders application), when a reminder notification is to be presented to the user, and, as illustrated by block 302, when an incoming phone or video call is received, which is likely to be the start of a long running user interaction that should not be interrupted, at least by ordinary reminders.

More specifically, reminder deferral can be initiated in at least the following scenarios. In one scenario, when a user creates a reminder, e.g., in a reminders application, the user can specify the deferral trigger condition 242, or a simplified representation thereof. For example, the user can specify that the reminder notification is to be presented when a particular meeting ends. In another scenario, when a reminder notification is to be presented based on the user's reminder condition (e.g., at a particular time, location, or the like), if automatic deferrals are enabled, the reminder notification can be deferred, without receiving user instructions, until a user-defined deferral trigger condition is met. Otherwise, if automatic reminders are not enabled, the reminder notification (e.g., a popup) can be presented in a user interface that includes options for deferring the reminder and explicitly specifying an action and the deferral trigger condition to be used to determine when, after the deferral, the reminder notification is to be presented. In another scenario, when a user receives an incoming phone call or video call, reminder notifications can be handled as described above for notifications based on the user's condition.

Returning to process 300, block 304 determines whether automatic deferral is enabled, e.g., by checking a configuration option or user preference setting. If automatic deferral is not enabled, a notification popup (or other appropriate type of user interface component) is presented to the user to request instructions as to whether to defer the notification, and, if so, which options to use. If automatic deferral is enabled, then the notification popup can be omitted, so that a notification can be deferred without interrupting the user. If block 304 determines that automatic deferral is enabled, then block 306 determines whether a notification deferral condition is met. The notification deferral condition can be set as a user preference, e.g., as a notification preference or as a phone application preference. If the notification deferral condition is true, then the notification can be deferred without interrupting the user, and control transfers to block 314. If automatic deferral is not enabled, or the notification deferral condition is not true, then the process continues at block 308 by displaying a call answering user interface, which can include reminder-related options for creating a deferred reminder. Block 310 determines whether the user selected a deferral option in the user interface. If not, there is no deferral to perform, and the process proceeds to allow the user to answer the incoming call at block 312. If so, the process continues to block 314, which creates a deferred notification reminder, for which a notification is to be generated. Block 314 can also be reached directly from block 304 when automatic deferral is enabled. The deferred notification reminder is scheduled to occur at a future time, e.g., by registering a callback with an event handler, starting a thread that waits until the appropriate event or time, or the like, and to perform a specified deferred action 208. In FIG. 3, the an incoming call is being deferred, so block 314 sets the deferred action 208 to Place Call 218, to cause the deferred notification to place a phone call when triggered (see block 320). A condition, referred to as a deferral trigger condition 242, is used to determine when the deferred notification is to be triggered, i.e., occur. The deferral trigger condition 242 can be received from the user, who can select it from a list of choices presented in the reminder deferral options displayed at block 308. The deferral trigger condition is true if the notification should be presented to the user, and false if the notification should be deferred. The deferred notification is to be presented at a subsequent (i.e., future) time at which a deferral trigger condition is met, e.g., is true or becomes true.

Block 316 represents the passing of time spent waiting until the deferred notification is presented, which occurs when the deferral notification trigger condition is or becomes true, as described above. The waiting time is shown for illustrative purposes. The process does not necessarily perform any action while waiting for the deferred notification. Block 320 is executed when the deferred notification is triggered. Block 320 performs the deferred action 208 associated with the reminder. In the process of FIG. 3, an incoming phone call is being deferred, so the deferred action 208 has been set (at block 314) to Place Call 218. Thus, block 320 places a call. The deferred action 208 can have other values in other scenarios as appropriate. For example, in a process that defers a reminder notification, the deferred action 208 can display the reminder text, in which case the deferred action 208 is set to Display Reminder 214. The reminder action can be any of the actions shown in FIG. 2, or other desired actions. Once the reminder action has been performed at block 320, the reminder notification has been presented, and the process ends.

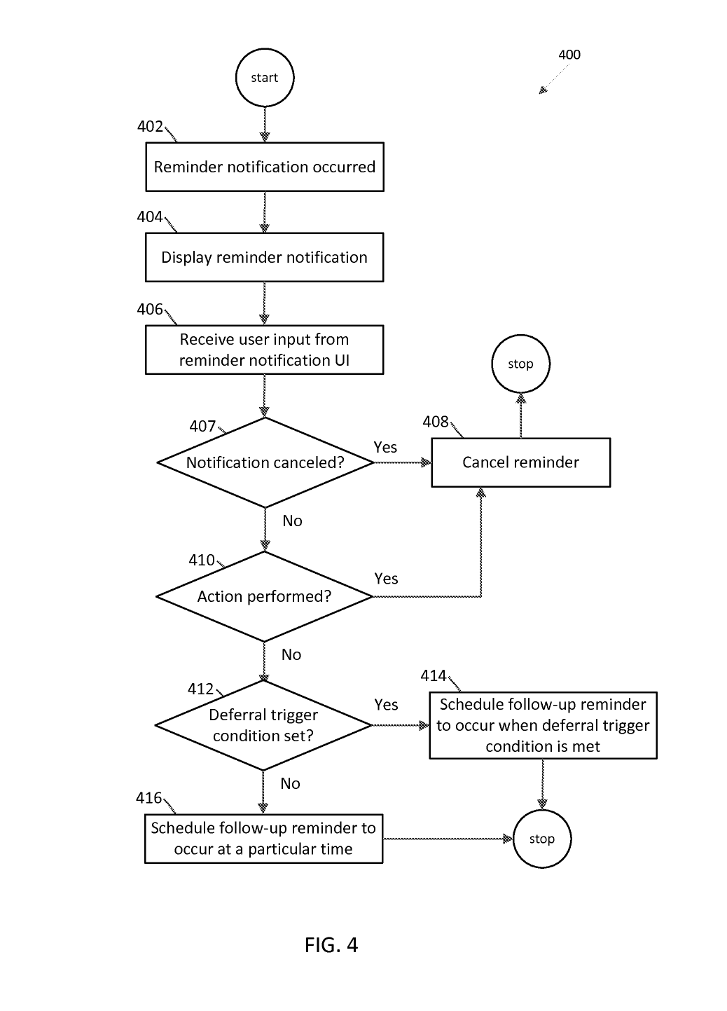

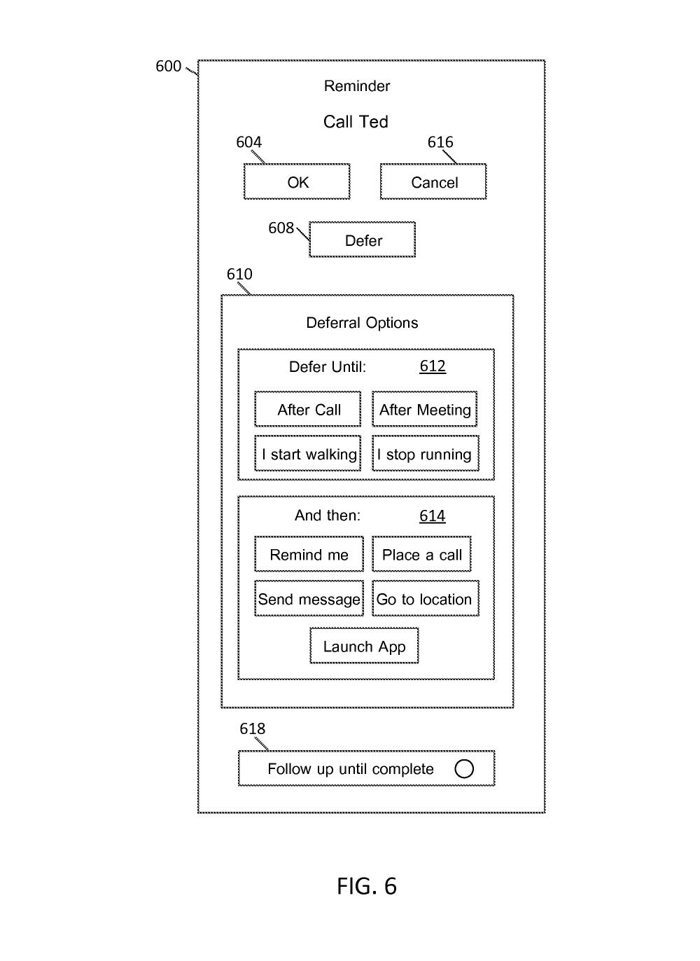

FIG. 4 is an illustrative flowchart of a process 400 for deferring notifications in accordance with one or more embodiments. Process 400 can be implemented as, for example, computer program code stored on a computer readable medium and executable by a processor to perform the described operations. Process 400 can be invoked when, for example, a reminder notification is triggered, at which point block 402 is invoked. Block 404 displays the reminder notification in notification user interface such as that shown in FIG. 6. Block 406 receives user input from the notification user interface. The user can select a follow-up option 614 in the user interface 600 so that one or more follow-up reminders will be generated to verify that the action specified in the reminder has been carried out. The follow-up flag 212 of the reminder can be set to true to indicate that follow-ups are enabled for the reminder. If block 407 determines that the user has selected a Cancel option in the notification user interface 600, then the reminder is canceled at block 408, and no further notifications are generated for the reminder. Otherwise, block 410 determines whether the action associated with the reminder has been performed. In one example, the user can indicate that the action has been performed, e.g., by checking a box in a reminder notification. In other examples, the user need not indicate that the action has been performed if the state information can be used to make the determination. Thus, to automatically determine if the action has been performed, for action types that have an action verification condition 210, block 410 can evaluate the verification condition 210 to determine if the action has been performed.

For example, if the deferred action 208 is Place Call 218, then the Call Placed 220 verification condition returns true if a call has been placed for the reminder 200. If block 410 determines that the action has been performed, e.g., by receiving explicit confirmation from the user or via a verification condition, or in some other way, then control transfers to block 408, the reminder is canceled, and the process ends. Otherwise, if block 410 determines that the action has not been performed, then a follow-up reminder can be scheduled. The time at which the follow-up reminder occurs (i.e., is triggered) can be specified explicitly, e.g., as an absolute time value or a time value relative to the current time. The follow-up reminder can alternatively be scheduled to occur when a condition is met. The condition can be specified by the user, e.g., by selecting options in the reminder notification user interface displayed at block 404. The condition can be, for example, a deferral trigger condition, which can be received at block 406 from the user interface displayed at block 404. Block 412 determines whether a deferral trigger condition has been set. If so, block 414 schedules a follow-up reminder to occur at a time when the deferral trigger condition is met. Otherwise, if there is no deferral trigger condition, block 416 block 416 schedules a follow-up reminder to occur at a specific time. The time can be, for example, 10 minutes from the current time, or 1 hour, or 1 day, and so on. The deferred notification can be used in addition to or in place of the aforementioned time-based notification. Once the follow-up reminder has been scheduled, the process ends. When the follow-up reminder is triggered, the process 400 is executed again, starting at block 402, to determine whether the action has been performed. If the action has still not been performed, another follow-up reminder can be generated, and so on until the action is performed, or a limit on the number of follow-up reminders is reached, or the user cancels a follow-up reminder, which stops the repeated invocations of the follow-up process 400.

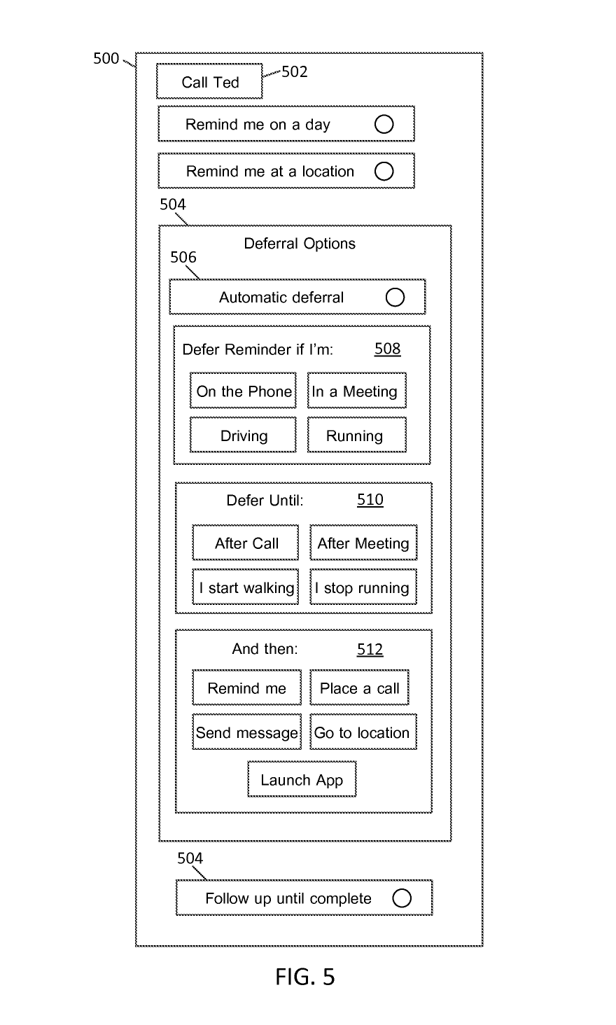

FIG. 5 is an illustrative drawing of a reminder creation user interface 500 in accordance with one or more embodiments. The reminder creation user interface 500 is displayed when, for example, a reminder is created, which can occur in a reminders application. The user interface 500 includes reminder text 502, which describes the reminder and the action to be performed, a reminder deferral user interface 504, in which the user can choose deferral options to cause the reminder notification to be deferred until a future time in certain user states, and a follow-up reminder flag 506, which the user can select to cause the reminder to be generated repeatedly, using follow-up reminders, until the action is completed or a reminder is canceled. An automatic deferral selector 506 can be used to enable or disable automatic deferrals.

A notification deferral condition selector 508 can be used to select a particular condition under which the notification for the reminder defined in the interface 500 is to be deferred. The selected notification deferral condition can be, for example, at least one of On the Phone, In a Meeting, Driving, or Running. The notification deferral condition is ordinarily used when automatic deferrals are enabled, so, in one embodiment, the notification deferral condition selector 508 is displayed only when the automatic deferral option 506 is selected.

A deferral trigger condition selector 510 can be used to select a particular condition under which the deferred notification is to be triggered. The selected action trigger condition can be, for example, at least one of After Call, After Meeting, When I Start Walking, When I Stop Running, or the like.

An Action selector 512 can be used to select a particular action to be performed when the deferred notification is triggered. The selected action can be, for example, Remind Me, Place a Call, Send Message, Go to Location, Launch Application, and so on. These example conditions and actions are shown for explanatory purposes, and other conditions and actions are possible.

FIG. 6 is an illustrative drawing of a reminder notification user interface 600 in accordance with one or more embodiments. The reminder notification user interface 600 includes a reminder text description 602, an OK button 604, which dismisses the reminder, a Defer button 608, which can defer the reminder until a specified deferred trigger condition based on deferral options 610 is met, an OK button 604, and a Cancel button 616, which cancels the reminder.

One or more of the Deferral Options 610 can be selected to control the deferral prior to pressing the Defer button 608. A deferral trigger condition selector 612 can be used to select a particular condition under which the deferred notification is to be triggered. The selected action trigger condition can be, for example, at least one of After Call, After Meeting, When I Start Walking, When I Stop Running, or the like.

An Action selector 614 can be used to select a particular action to be performed when the deferred notification is triggered. The selected action can be, for example, Remind Me, Place a Call, Send Message, Go to Location, Launch Application, and so on. These example conditions and actions are shown for explanatory purposes, and other conditions and actions are possible. Thus, a user can defer a reminder notification in the user interface 600 using default deferral options by selecting the Defer button 608, or by selecting one or more deferral options, and then selecting the Defer button 608.

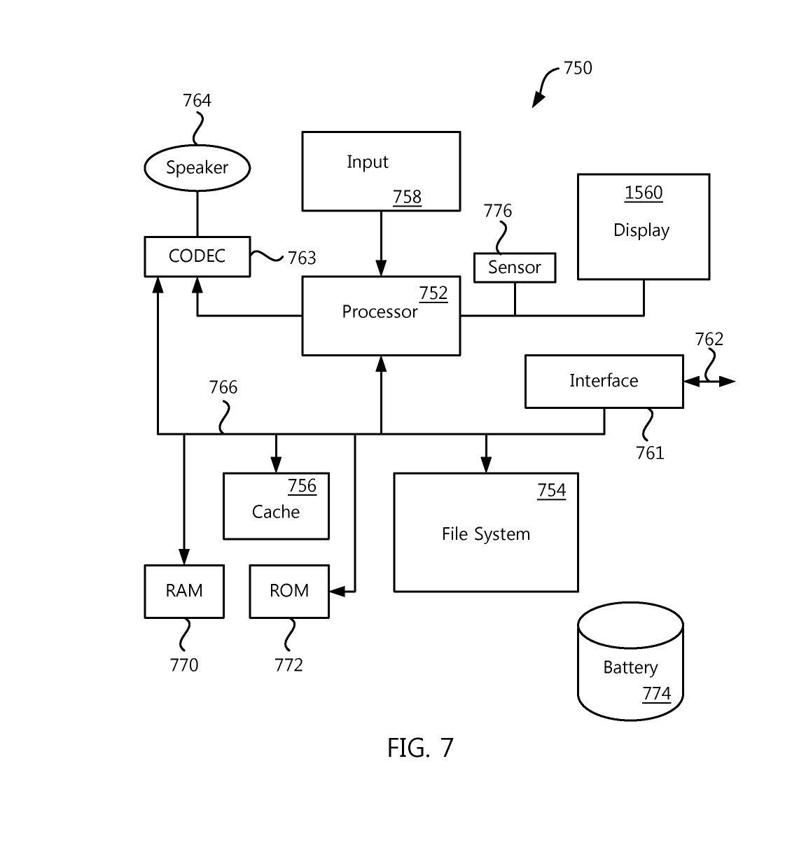

FIG. 7 is a block diagram of an electronic device 750 suitable for use with the described embodiments. The electronic device 750 illustrates circuitry of a representative computing device. The electronic device 750 includes a processor 752 that pertains to a microprocessor or controller for controlling the overall operation of the electronic device 750. The electronic device 750 stores media data pertaining to media items in a file system 754 and a cache 756. The file system 754 is, typically, a storage disk or a plurality of disks. The file system 754 typically provides high capacity storage capability for the electronic device 750. However, since the access time to the file system 754 is relatively slow, the electronic device 750 can also include a cache 756. The cache 756 is, for example, Random-Access Memory (RAM) provided by semiconductor memory. The relative access time to the cache 756 is substantially shorter than for the file system 754. However, the cache 756 does not have the large storage capacity of the file system 754. Further, the file system 754, when active, consumes more power than does the cache 756. The power consumption is often a concern when the electronic device 750 is a portable media device that is powered by a battery 774. The electronic device 750 can also include a RAM 770 and a Read-Only Memory (ROM) 772. The ROM 772 can store programs, utilities or processes to be executed in a non-volatile manner. The RAM 770 provides volatile data storage, such as for the cache 756.

The electronic device 750 also includes a user input device 758 that allows a user of the electronic device 750 to interact with the electronic device 750. For example, the user input device 758 can take a variety of forms, such as a button, keypad, dial, touch screen, audio input interface, visual/image capture input interface, input in the form of sensor data, etc. Still further, the electronic device 750 includes a display 760 (screen display) that can be controlled by the processor 752 to display information to the user. A data bus 766 can facilitate data transfer between at least the file system 754, the cache 756, the processor 752, and the CODEC 763.

In one embodiment, the electronic device 750 serves to store a plurality of media items (e.g., songs, podcasts, etc.) in the file system 754. When a user desires to have the electronic device play a particular media item, a list of available media items is displayed on the display 760. Then, using the user input device 758, a user can select one of the available media items. The processor 752, upon receiving a selection of a particular media item, supplies the media data (e.g., audio file) for the particular media item to a coder/decoder (CODEC) 763. The CODEC 763 then produces analog output signals for a speaker 764. The speaker 764 can be a speaker internal to the electronic device 750 or external to the electronic device 750. For example, headphones or earphones that connect to the electronic device 750 would be considered an external speaker.

The electronic device 750 also includes a network/bus interface 761 that couples to a data link 762. The data link 762 allows the electronic device 750 to couple to a host computer or to accessory devices. The data link 762 can be provided over a wired connection or a wireless connection. In the case of a wireless connection, the network/bus interface 761 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or visual content. Sensor 776 can take the form of circuitry for detecting any number of stimuli. For example, sensor 776 can include a Hall Effect sensor responsive to external magnetic field, an audio sensor, a light sensor such as a photometer, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A method of deferring a first reminder notification, the method comprising:
displaying, by a computer system, a reminder deferral user interface in response to the first reminder notification, the reminder deferral user interface specifying deferral options, including at least one deferral trigger condition;
receiving, by the computer system, a request to defer the first reminder notification, the request comprising a selected deferral trigger condition, selected from the at least one deferral trigger condition, that indicates when a second reminder notification is to be presented, wherein the selected deferral trigger condition is based upon state information associated with the computer system; and
scheduling, by the computer system, the second reminder notification to present a deferred reminder user interface at a subsequent time at which the selected deferral trigger condition is met.

2. The method of claim 1, wherein the at least one deferral trigger condition is based upon calendar data included in the state information, the calendar data includes at least one calendar event having a start time and an end time, and the deferral trigger condition is met when the current time is greater than the end time.

3. The method of claim 1, wherein the at least one deferral trigger condition is based upon a foreground application executing on the computer system, as identified by the state information, and the deferral trigger condition is met when the foreground application becomes a background application or exits.

4. The method of claim 1, the at least one deferral trigger condition is based upon motion data included in the state information, and the deferral trigger condition is met when the motion data indicates a change in the user's motion.

5. The method of claim 4, wherein the change in the user's motion comprises a change from driving to walking.

6. The method of claim 1, wherein the deferral options further include at least one deferral action, and the request comprises a selected deferral action, selected from the at least one deferral action, that is to be performed when the deferral trigger condition is met.

7. The method of claim 1, wherein the deferred reminder user interface comprises a reminder notification user interface, and the method further comprises:
presenting, by the computer system the reminder notification user interface when the selected deferral trigger condition is met.

8. The method of claim 1, further comprising receiving a selected deferral action, the selected deferral action to be performed when the reminder notification is presented, the selected deferral action selected from the at least one deferral action, and the deferred reminder user interface indicates that the selected deferral action is to be performed.

9. The method of claim 8, wherein the first reminder notification comprises a notification of an incoming call, and the selected deferral action comprises calling a number associated with the incoming call.

10. The method of claim 8, wherein the first reminder notification comprises a notification of a received message, and the selected deferral action comprises sending a response to the received message.

11. A system for generating follow-up reminders until a reminder action has been performed, the system comprising:
a processor;
a memory storing computer executable instructions that when executed by the processor cause the processor to:
present, in a notification user interface, a first reminder notification that describes an action to be performed by a user
receive, in the notification user interface, a request to schedule a follow-up notification for the action;
determine whether the action has been performed; and
schedule, in response to determining that the action has not been performed, a follow-up notification to occur at a subsequent time or to occur when a condition is met.

12. The system of claim 11, wherein the follow-up notification comprises a reminder notification that describes the action to be performed by the user, wherein the subsequent time is based upon a defined time period.

13. The system of claim 11, wherein the instructions, when executed by the processor, further cause the processor to:
receive, in the notification user interface, a deferral trigger condition, wherein to schedule the follow-up notification; and
schedule the follow-up notification to occur when the deferral trigger condition is met.

14. The system of claim 13, wherein the follow-up notification comprises a reminder notification that describes the action to be performed by the user.

15. The system of claim 13, wherein the follow-up notification comprises an action to be performed, wherein the instructions, when executed by the processor, further cause the processor to:
receive the action to be performed when the follow-up notification occurs, wherein scheduling the follow-up notification comprises scheduling the action to be performed when the deferral trigger condition is met.

16. The method of claim 11, wherein the action has been performed if an input has been received from the user indicating that the action has been performed.

17. The method of claim 11, wherein the instructions, when executed by the processor, further cause the processor to determine, based upon the state information, whether the action has been performed.

18. A non-transitory machine-readable medium for a computer system, the non-transitory machine-readable medium having stored thereon a series of instructions executable by a processor to automatically defer a first reminder notification until a reminder action has been performed, the series of instructions comprising:
instructions that cause the processor to. in response to the first reminder notification, determine whether the action has been performed; and
instructions that cause the processor to schedule a second reminder notification to present a deferred reminder user interface when the deferral trigger condition is met, wherein the deferral trigger condition is based upon state information associated with the computer system.

19. The non-transitory machine-readable medium of claim 18, the series of instructions further comprising:
instructions that cause the processor to determine whether the reminder action has been performed; and
instructions that cause the processor to schedule a follow-up notification in response to determining that the reminder action has not been performed, wherein the follow-up notification comprises a reminder notification that describes the action to be performed by the user, and scheduling the follow-up notification comprises scheduling the follow-up notification to occur at a particular time.

20. The non-transitory machine-readable medium of claim 19, the series of instructions further comprising instructions that cause the processor to determine, based upon the state information, whether the action has been performed.
